(19) United States
(12) Patent Application Publication
(10) Pub. No.: US 2009/0022835 A1
(43) Pub. Date: Jan. 22, 2009

(54) Injection molding machine with two tie bars

(76) Inventor: Jui-Hsiang Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,547

(22) Filed: Jul. 17, 2007

(51) Int. Cl. B29C 45/00

(52) U.S. Cl. 425/110

(57) ABSTRACT

A molding machine includes a bed, a stationary and a moving mold holding plates, an adjustment plate, two tie bars, and a mechanism for driving the moving mold holding plate; both the mold holding plates are arranged on the bed for holding female and male parts of a mold respectively; the adjustment plate is positioned on the bed; the moving mold holding plate is connected to the tie bars so as to be moved along the tie bars when the driving mechanism is actuated; the tie bars pass through all of the plates in such a position as to intersect a diagonal line of each of the plates; to install the mold, male and female parts of the mold can be passed through space next to adjacent vertical and horizontal sides of the holding plates, which don't have a tie bar intervening between them to interfere with installation.

### BACKGROUND OF THE INVENTION

1. Field of the Invention

The present invention relates to an injection molding machine, more particularly one, which comprises two tie bars passing through two corners of a stationary and a moving mold holding plates that are on a same diagonal; thus, interference of tie bars with installing/dismounting a mold is prevented.

2. Brief Description of the Prior Art

Plastic products are very common in our daily life, e.g. cups, trays, containers, housings of various electrical appliances, and certain parts of cars and motorbikes. And, a large proportion of household appliances either partially or completely comprise plastic parts, which are usually formed by means of injection molding machines.

The injection molding process with an injection molding machine includes injecting melted plastic materials, which are usually macromolecule polymer, into a mold to shape the melted materials into a product, which is next cooled to become solid, and taken out of the mold by means of a proper means.

A common injection molding machine comprises a bed, a driving mechanism on one end portion of the bed, a material ejecting tube disposed at a front of the driving mechanism to inject melted plastic materials into a mold, a funnel to feed plastic materials into the material ejecting tube, and a screw, which is held in the material feeding tube, and rotated to push plastic materials forwards by means of the driving mechanism. The material ejecting tube is further equipped with a heating device. Referring to FIGS. 7 and 8, sectional views of the injection molding machine, the injection molding machine further includes a stationary mold holding plate, a moving mold holding plate, and an adjustment plate, which are all denoted by numeral 9, a driving mechanism, four tie bars 93, and a mold, which comprises a male and a female parts 91 respectively joined to the stationary and the moving mold holding plates. The stationary mold holding plate, the driving mechanism, the moving mold holding plate, and the adjustment plate are arranged on the other end portion of the bed. The four tie bars 93 are respectively passed through four corners of the stationary mold holding plate, the moving mold holding plate, and the adjustment plate; thus, the moving mold holding plate can be moved towards/away from the stationary mold holding plate along the tie bars 93 to close/open the mold by means of the driving mechanism.

The mold-locking strength of an injection molding machine means how much force the machine can exert to lock a mold at most, and it is usually denoted in tons, and should be greater than the product of the projection area of a molded product and the average pressure inside the mold cavity. The mold-locking strength of an injection molding machine also can be obtained by multiplying the amount of force that a tie bar can bear at most by four (the number of tie bars). Therefore, an injection molding machine will have a great mold-locking strength if tie bars of a large diameter are used.

In addition, a certain inventor invented an improvement on an adjustment device for a moving mold holding plate of an injection molding machine in order to prevent tie bars of the molding machine from being curved. The adjustment device includes sliding pieces, adjustment bolts, and angle racks. The sliding pieces have several screw holes thereon while the angle racks have fixing holes on a bottom thereof. The adjustment bolts have protruding posts, which are passed through the screw holes of the sliding pieces, the moving mold holding plate, and the fixing holes of the angle racks. Therefore, the moving mold holding plate can be adjusted in position in relation to a vertical as well as a horizontal so as to be smoothly moved to open/close a mold.

Referring to FIG. 7 again, the above injection molding machine is found to have the following drawbacks: to install the mold on the injection molding machine by means of a moving device 92; the male part/female part 91 of the mold are hung on the moving device 92, and moved onto the moving mold holding plate/stationary mold holding plate 9 through the space between two of the tie bars 93. Therefore, in installation, it is very possible for the male part/female part 91 of the mold to hit and cause deformation and damage to the tie bars 93; the moving mold holding plate 9 can't be smoothly moved along the tie bars 93 if the tie bars 93 are curved or deformed. And, it takes relatively much time, labor and attention, and extra carefulness for the operators to install/dismount the mold without the mold parts 91 hitting the tie bars 93. Consequently, the manufacturing cost is increased.

In addition, referring to FIG. 8 again, after an injection molding action is finished, the moving mold plate 9 is moved away from the stationary mold holding plate to open the mold, and the product is picked out of the mold by means of a mechanical manipulator (B); because the molding machine the tie bars 93 are passed through four corners of each of the stationary and the moving mold holding plates 9, they can interfere with the mechanical manipulator (B); in other words, it is very possible for the mechanical manipulator (B) to hit the tie bars 93 in operation. Consequently, there will be relatively much trouble in programming the mechanical manipulator (B).

### SUMMARY OF THE INVENTION

It is a main object of the invention to provide an improvement on an injection molding machine to overcome the above problems.

An injection molding machine according to an embodiment of the present invention includes a bed, a stationary and a moving mold holding plates, an adjustment plate, a driving mechanism, and two tie bars; the stationary and the moving mold holding plates are arranged on the bed for holding female and male parts of a mold respectively; the adjustment plate is positioned on the bed; the driving mechanism provides power to the moving mold holding plate; the moving mold holding plate is connected to the tie bars such that it can be moved along the tie bars by means of the driving mechanism; the tie bars pass through all of the plates in such a position as to intersect a diagonal line of each of the plates. In installing/dismounting the mold, the mold parts are moved via space next to adjacent vertical and horizontal sides of the holding plates, which don't have a tie bar intervening between them to interfere with the installing/dismounting action. Furthermore, the technician can inspect, maintain and repair the molding machine and the mold more easily.

### BRIEF DESCRIPTION OF THE DRAWINGS

The present invention will be better understood by referring to the accompanying drawings, wherein:

FIG. 1 is a side view of the present invention,

FIG. 2 is a sectional view of the present invention,

FIG. 3 is a sectional view of the present invention, with the tie bars intersecting a diagonal line of the moving mold holding plate, which connects a left upper corner and a right lower corner,

FIG. 4 is a sectional view of the present invention, with the tie bars intersecting a diagonal line of the moving mold holding plate, which connects a right upper corner and a left lower corner (1),

FIG. 5 is a sectional view of the present invention, with the tie bars intersecting a diagonal line of the moving mold holding plate, which connects a right upper corner and a left lower corner (2),

FIG. 6 is a view of the present invention, taken when a mechanical manipulator is being used to pick a product out of the mold,

FIG. 7 is a sectional view of the prior art, and

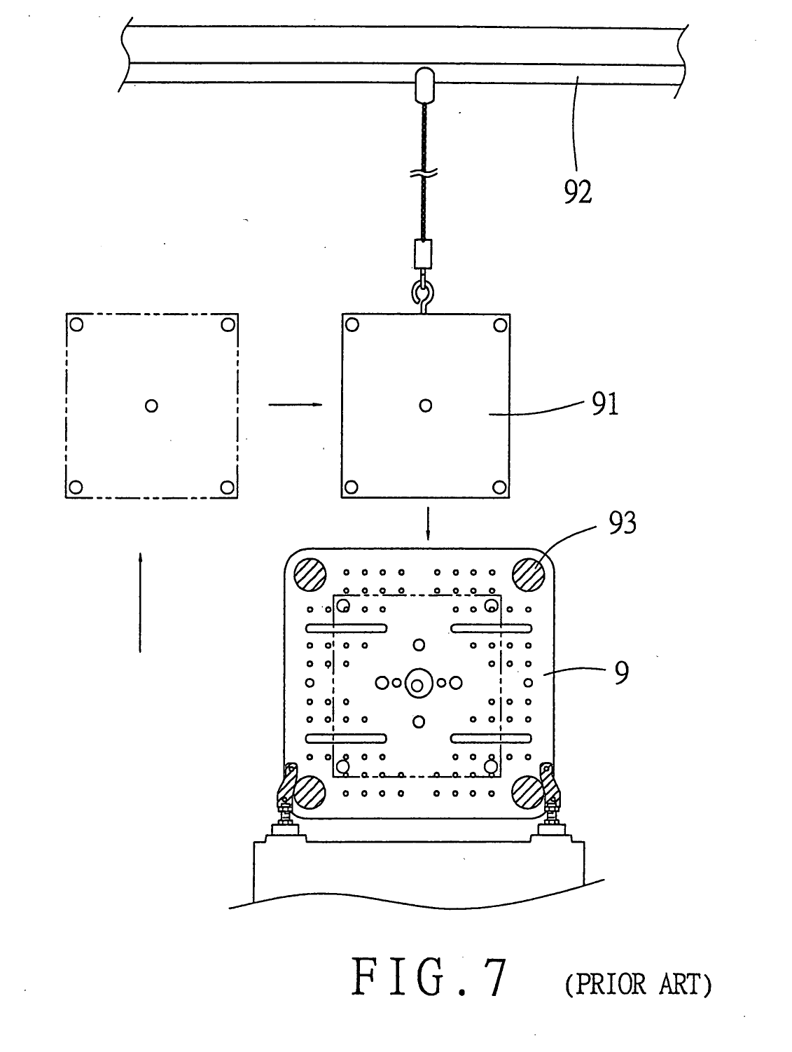

FIG. 8 is a view of the prior art, taken when a tool is being used to pick a product out of the mold.

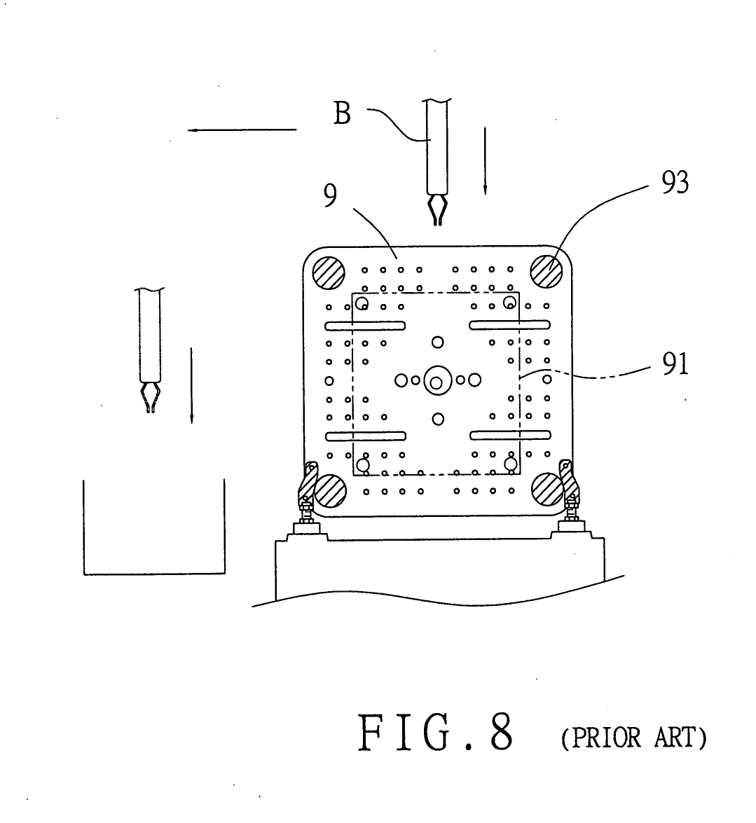

### DETAILED DESCRIPTION OF THE PREFERRED EMBODIMENTS

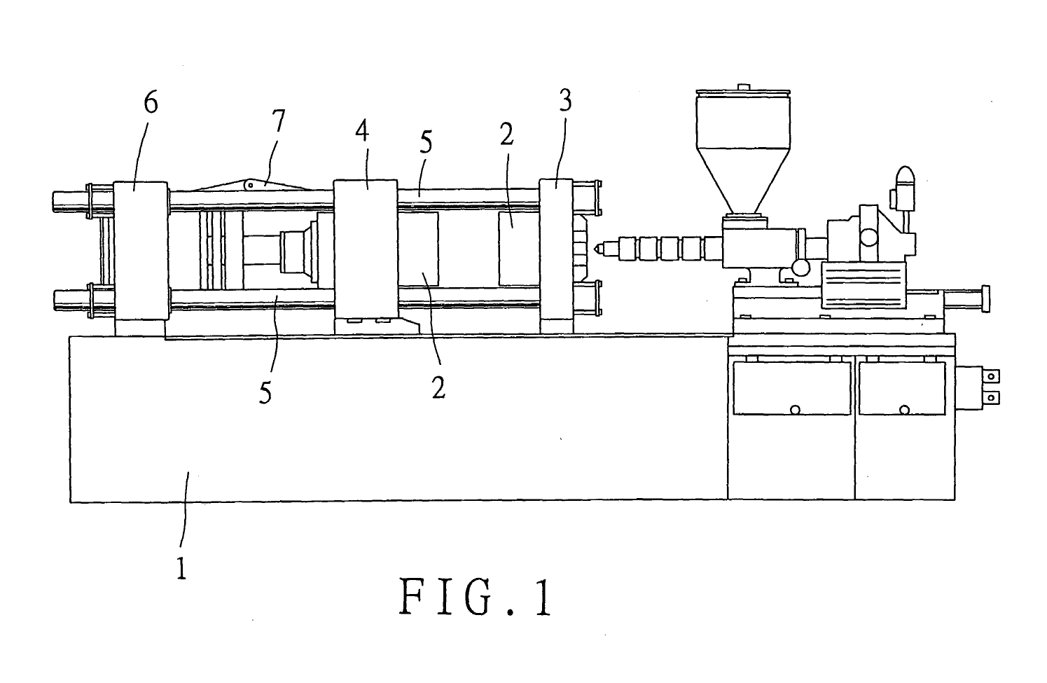

Referring to FIG. 1, an injection molding machine of the present invention includes a bed 1, a stationary mold holding plate 3, a moving mold holding plate 4, an adjustment plate 6, a driving mechanism 7, two tie bars 5, and a mold 2. The stationary mold holding plate 3, the driving mechanism 7, the moving mold holding plate 4, and the adjustment plate 6 are arranged on the bed 1. The mold comprises a male part, and a female part, which are joined to the stationary and the moving mold holding plates 3 and 4 respectively. The tie bars 5 are passed through the stationary mold holding plate 3, the moving mold holding plate 4, and the adjustment plate 6; thus, the moving mold holding plate 4 can be moved towards/away from the stationary mold holding plate 3 along the tie bars 5 to close/open the mold 2 by means of the driving mechanism 7.

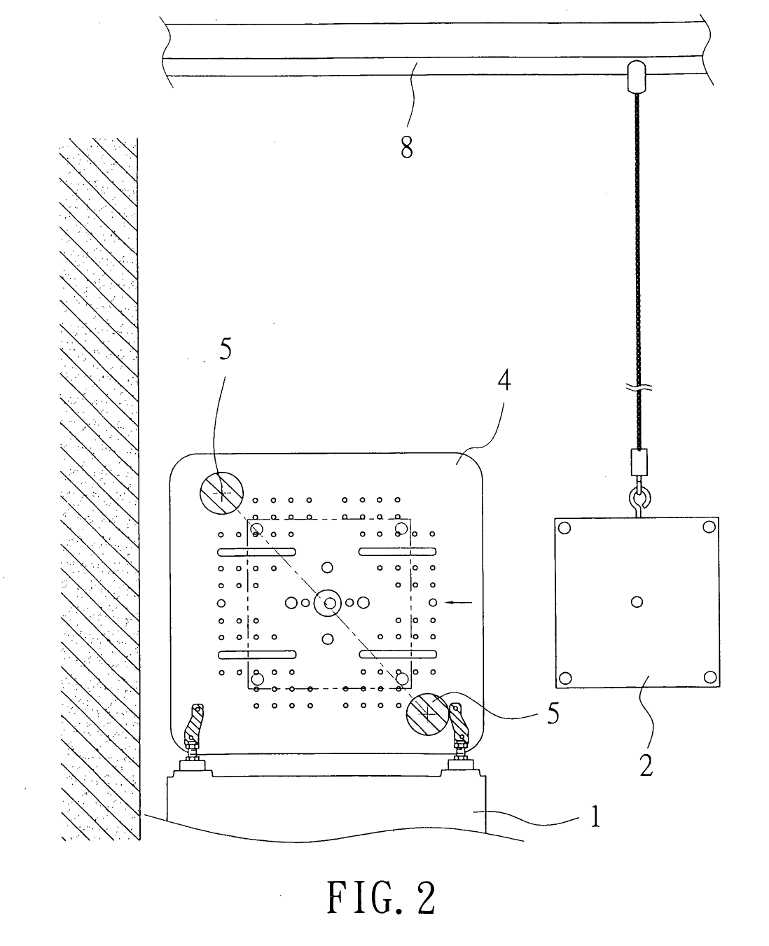

Referring to FIG. 2, the tie bars 5 are arranged so as to intersect a diagonal line of each of the stationary mold holding plate 3, the moving mold holding plate 4, and the adjustment plate 6, which connect two of four corners. Therefore, there is no tie bar on the other two corners of the stationary mold holding plate 3 or the other two corners of the moving mold holding plate 4; in other words, each of the stationary mold holding plate 3 and the moving mold holding plate 4 has adjacent vertical and horizontal sides that don't have a tie bar intervening between them. Consequently, installation and dismounting of the mold 2 will be easier.

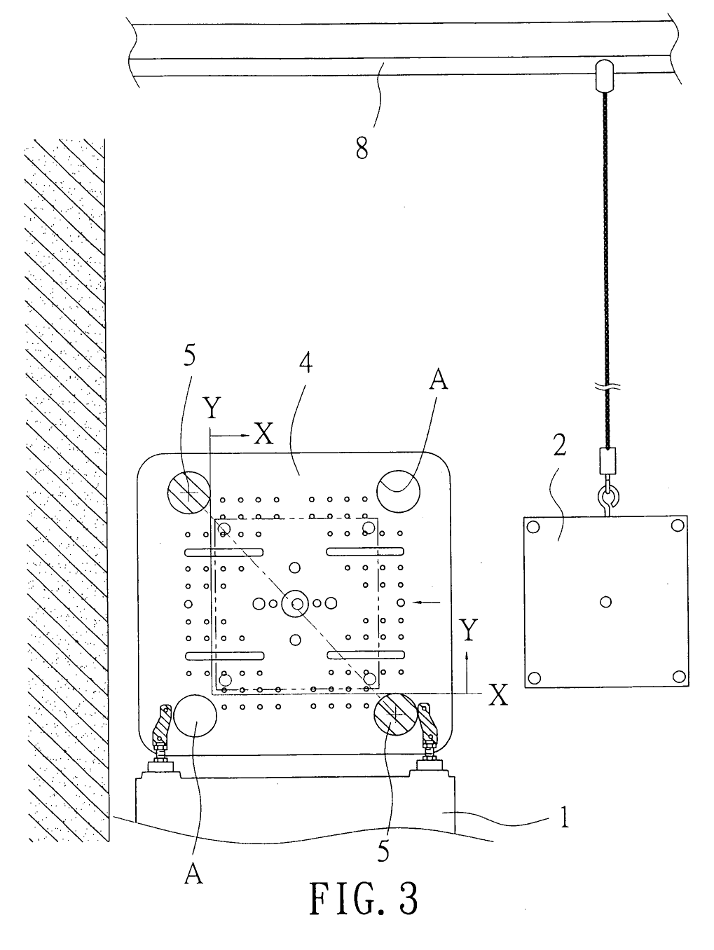

FIG. 3 is a sectional view of the first preferred embodiment of the injection molding machine of the present invention: each of a stationary mold holding plate 3, a moving mold holding plate 4, and an adjustment plate 6 of the molding machine has a hole (A) on each of four corners thereof; the molding machine has two tie bars 5, which are respectively passed through a right upper one, and a left lower one of holes (A) of each of the stationary mold holding plate 3, the moving mold holding plate 4, and the adjustment plate 6. Each of the stationary mold holding plate 3, the moving mold holding plate 4, and the adjustment plate 6 can be formed with only two holes (A) instead of four, as shown in FIG. 2. The mold 2 is installed on the molding machine by means of a moving device 2; the male part/female part of the mold 2 can be moved onto the moving mold holding plate 4/stationary mold holding plate 3 via the space next to adjacent right vertical and upper horizontal sides of the moving mold holding plate 4/stationary mold holding plate 3, which don't have a tie bar intervening between them to interfere with the installation, as shown in FIG. 3. Or alternatively, the male part/female part of the mold 2 can be moved onto the moving mold holding plate 4/stationary mold holding plate 3 via the space next to adjacent left vertical and lower horizontal sides of the moving mold holding plate 4/stationary mold holding plate 3, which don't have a tie bar intervening between them to interfere with the installation. Therefore, it takes less time and is relatively easy to install/dismount the mold 2.

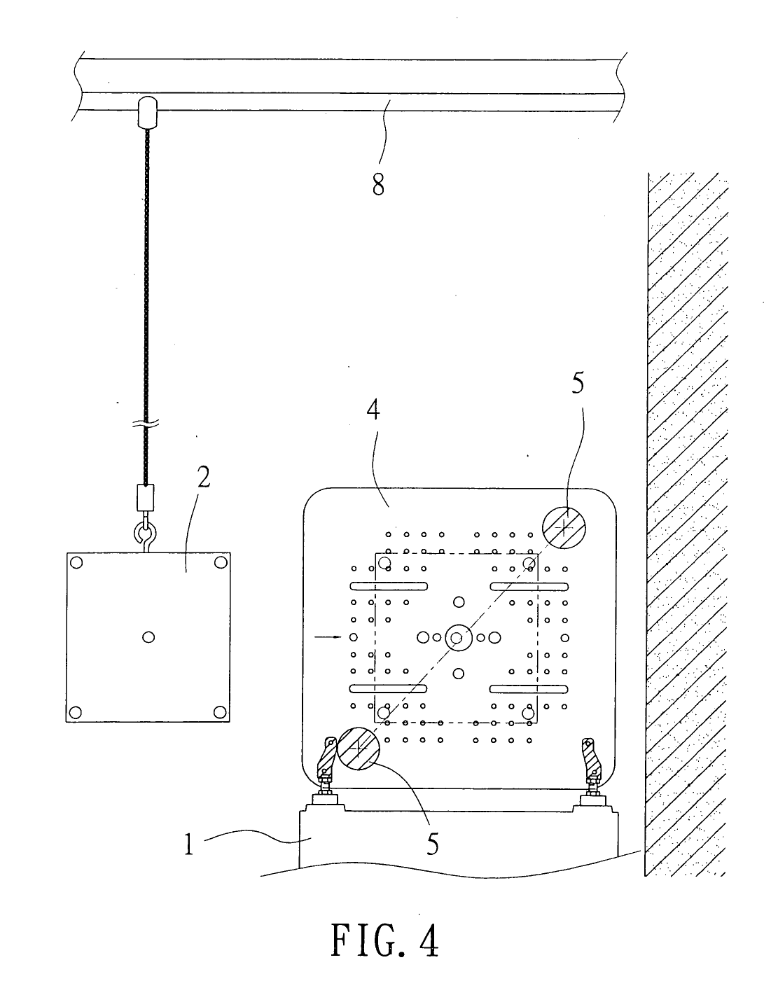

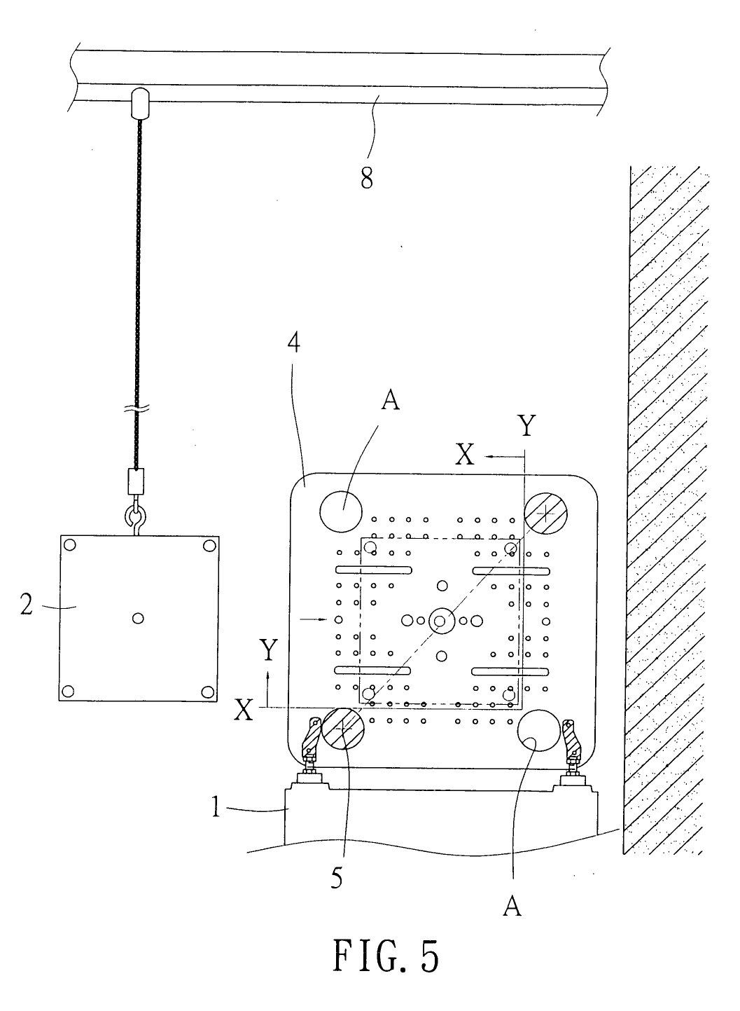

FIG. 5 is a sectional view of the second preferred embodiment of the injection molding machine of the present invention: each of a stationary mold holding plate 3, a moving mold holding plate 4, and an adjustment plate 6 of the molding machine has a hole (A) on each of four corners thereof; the molding machine further has two tie bars 5, which are respectively passed through a right upper one, and a left lower one of holes (A) of each of the stationary mold holding plate 3, the moving mold holding plate 4, and the adjustment plate 6. Referring to FIG. 4, each of the stationary mold holding plate 3, the moving mold holding plate 4, and the adjustment plate 6 can be formed with only two holes (A) instead of four. The mold 2 is installed on the molding machine by means of a moving device 8; the male part/female part of the mold 2 can be moved onto the moving mold holding plate 4/stationary mold holding plate 3 via the space next to adjacent left vertical and upper horizontal sides of the moving mold holding plate 4/stationary mold holding plate 3, which don't have a tie bar intervening between them to interfere with the installation. Or alternatively, the male part/female part of the mold 2 can be moved onto the moving mold holding plate 4/stationary mold holding plate 3 via the space next to adjacent right vertical and lower horizontal sides of the moving mold holding plate 4/stationary mold holding plate 3, which don't have a tie bar intervening between them to interfere with the installation. Therefore, it takes less time and is relatively easy to install/dismount the mold 2.

The two tie bars 5 are used to bear the reacting force in opening/closing the mold instead of four therefore the diameter of the tie bars 5 of the molding machine of the present invention should be 1.414 (√2) times that of the tie bars of an equivalent molding machine with four tie bars. Therefore, the total volume of the tie bars 5 of the present invention isn't greater than that of the four tie bars of an equivalent molding machine.

Furthermore, the thickness of the stationary mold holding plate 3, the moving mold holding plate 4, and the adjustment plate 6 can be increased so as to increase the area of contact between each said tie bar 5 and the stationary mold holding plate 3/the moving mold holding plate 4/the adjustment plate 6. Therefore, the two tie bars 5 of the present invention can effectively bear the reacting force in opening/closing the mold while they have the same diameter as the four tie bars of an equivalent molding machine; at the same time, the money saved from reducing the number of the tie bars is enough to offset the additional expense resulting from increase of the thickness of the stationary mold holding plate 3, the moving mold holding plate 4, and the adjustment plate 6.

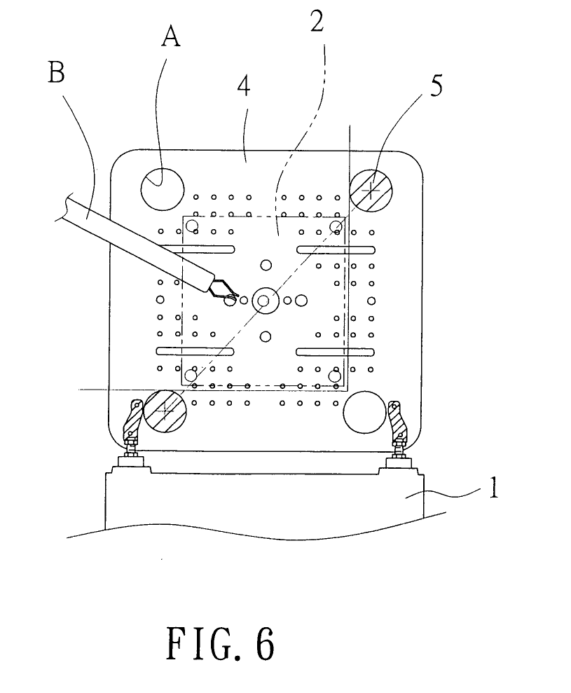

Referring to FIG. 6, the moving mold holder 4 is moved away from the stationary mold holding plate 3 to open the mold 2, and a product is picked out of the mold 2 by means of a mechanical manipulator (B) after an injection molding action is finished; because the molding machine comprises only two tie bars arranged in a diagonal manner relative to the stationary mold holding plate 3 and the moving mold holding plate 4, the mechanical manipulator (B) can be easily operated without being interfered with by the tie bars.

From the above description, it can be seen that the present invention has the following advantages:

1. The tie bars are arranged in such a manner as to intersect a diagonal line of each of the plates, which connect two of four corners. Therefore, each of the moving and the stationary mold holding plates has adjacent vertical and horizontal sides that don't have a tie bar intervening between them. Consequently, it will be easier to install/dismount a mold.

2. The molding machine of the present invention comprises only two tie bars instead of four. The tie bars of the present invention have a greater diameter than the tie bars of an equivalent molding machine with four tie bars to be strong enough to bear reacting force, yet it takes less material cost to fabricate the present invention than it does to fabricate an equivalent molding machine with four tie bars.

3. The molding machine of the invention can be equipped with two tie bars, which have a greater diameter than the tie bars of an equivalent molding machine with four tie bars to be strong enough to bear reacting force. Or alternatively, the molding machine can be equipped with a moving plate, a stationary plate, and an adjustment plate that have a greater thickness in order for the two tie bars to bear reacting force. The fabrication cost of the present invention can't be higher than that of an equivalent molding machine with four tie bars no matter which one of the above ways is used.

4. To pick a molded product from the mold parts by means of a mechanical manipulator, the mechanical manipulator can be moved onto the mold parts via the space next to adjacent vertical and horizontal sides of the moving mold holding plate/stationary mold holding plate that don't have a tie bar intervening between them to interfere with motion of the mechanical manipulator.

1. An injection molding machine, comprising:
a bed,
a stationary mold holding plate positioned on the bed for holding a part of a mold,
a moving mold holding plate positioned on the bed for holding another part of the mold, the mold enters into the moving mold holding plate in the horizontal direction to be placed in the center of the moving mold holding plate to be molded to a desired shape;
an adjustment plate positioned on the bed,
a driving mechanism to supply power to the moving mold holding plate, and
a pair of diagonally displaced tie bars, the moving mold holding plate being connected to the diagonally located tie bars so as to be moved relative to the stationary mold holding plate solely along the tie bars when the driving mechanism is actuated; the tie bars passing through the stationary mold holding plate, the moving mold holding plate, and the adjustment plate in such a position as to intersect a diagonal line of each of the stationary mold holding plate, the moving mold holding plate, and the adjustment plate, the moving mold holding plate having only two diagonally located tie bars to permit a mold to be inserted which reduces interference between the tie bars and the inserted mold.

2. An injection molding machine, comprising:
a bed,
a stationary mold holding plate positioned on the bed for holding a part of a mold,
a moving mold holding plate positioned on the bed for holding another part of the mold, the mold enters into the moving mold holding plate in the horizontal direction to be placed in the center of the moving mold holding plate to be molded to a desired shape;
an adjustment plate positioned on the bed,
each of the stationary mold holding plate, the moving mold holding plate, and the adjustment plate having a hole on each of four corners thereof;
a driving mechanism to supply power to the moving mold holding plate, and
a pair of diagonally displaced tie bars, the moving mold holding plate being connected to the diagonally located tie bars so as to be moved relative to the stationary mold holding plate solely along the tie bars when the driving mechanism is actuated; the tie bars passing trough two of said holes of each of the stationary mold holding plate, the moving mold holding plate, and the adjustment plate, which are on a diagonal line, the moving mold holding plate having only two diagonally located tie bars to permit a mold to be inserted which reduces interference between the tie bars and the inserted mold.

3. The injection molding machine as claimed in claim 1, wherein said diagonal line of each of the stationary mold holding plate, the moving mold holding plate, and the adjustment plate connects a left upper corner and a right lower corner.

4. The injection molding machine as claimed in claim 1, wherein said diagonal line of each of the stationary mold holding plate, the moving mold holding plate, and the adjustment plate connects a right upper corner and a left lower corner.

5. The injection molding machine as claimed in claim 2, wherein said diagonal line of each of the stationary mold holding plate, the moving mold holding plate, and the adjustment plate connects a left upper corner and a right lower corner.

6. The injection molding machine as claimed in claim 2, wherein said diagonal line of each of the stationary mold holding plate, the moving mold holding plate, and the adjustment plate connects a right upper corner and a left lower corner.
